(19) United States
(12) Patent Application Publication
(10) Pub. No.: US 2008/0237154 A1
(43) Pub. Date: Oct. 2, 2008

(54) FILTER DEVICE FOR A DISHWASHER, AND ASSOCIATED APPARATUS AND METHOD

(75) Inventors: John C. Bragg, Evansville, IN (US); Douglas J. Nagel, Kinston, NC (US); Gregory A. Meyer, Batesville, IN (US); Rolf Stahlmann, Wolframs-Eschenbach (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/019,106

(22) Filed: Jan. 24, 2008

Related U.S. Application Data
(60) Provisional application No. 60/888,484, filed on Feb. 6, 2007.

(51) Int. Cl. B01D 37/00; A47L 15/42; B01D 29/00

(52) U.S. Cl. 210/808; 210/435; 134/110; 210/767

(57) ABSTRACT

A filter device for a dishwasher and associated apparatus and method are provided. The filter device includes an elongate housing having opposed ends, with one of the ends defining a fluid inlet. The housing is configured to define a channel therein extending between the opposed ends and has an upper wall and substantially vertical opposing side walls extending therefrom. The upper wall comprises a solid member, and at least one of the side walls comprises a fine mesh filtering screen, wherein washing fluid directed into the fluid inlet is filtered by the fine mesh filtering screen such that soil suspended therein is retained within the channel while the washing fluid passes through the fine mesh filtering screen and out of the channel.

### CROSS-REFERENCE TO RELATED APPLICATIONS

This application claims the benefit of U.S. Provisional Application No. 60/888,484, filed Feb. 6, 2007, the contents of which are incorporated herein by reference.

### BACKGROUND OF THE INVENTION

1. Field of the Invention

Embodiments of the present invention relate to dishwashers and, more particularly, to a filter device for a dishwasher, and an apparatus and method associated therewith.

2. Description of Related Art

A dishwasher includes a front-opening wash tub for containing the dishware to be washed. Generally, the tub includes a sump disposed at the lower end thereof. Water sprayed from the spray arms within the tub, onto the dishware therein, drains into the sump along with food soils and debris from the dishware. Because the water collected in the sump is re-circulated through the spray arms during the wash and rinse cycles, the dishwasher usually includes a filtration system associated with the sump and/or the circulation pump (which pumps the water through the spray arms). The filtration system is configured to remove the food soils and debris from the water being circulated by the circulation pump during the wash and rinse cycles, and may include both a coarse filter for removing larger particles from the water and a fine filter for further removing fine particles from the water.

Some prior filters are horizontally mounted in the bottom or sump of the dishwasher. That is, such horizontally-mounted fine filters are oriented such that the filtering material or mesh is horizontally disposed. In such a configuration, the filtering material may be at risk of being damaged or punctured by falling objects from the racks above, such as sharp knives or forks, and therefore must be protected from such falling objects. In some instances, a shield may be added to the spray arm assembly, to the sump, or in other manners, to protect the fine filter from falling objects, though such a shield may often impede access to other components of the dishwasher (i.e., impede access to the glass trap for cleaning the same). Accordingly, an improved fine filter device for a dishwasher would be desirable.

### BRIEF SUMMARY OF THE INVENTION

The above and other needs are met by the present invention which, in one aspect, provides a filter device for a dishwasher. Such a filter device comprises an elongate housing having opposed ends, with one of the ends defining a fluid inlet. The housing is configured to define a channel therein extending between the opposed ends and has an upper wall and substantially vertical opposing side walls extending therefrom. The upper wall comprises a solid member, and at least one of the side walls comprises a fine mesh filtering screen, wherein washing fluid directed into the fluid inlet is filtered by the fine mesh filtering screen such that soil suspended therein is retained within the channel while the washing fluid passes through the fine mesh filtering screen and out of the channel.

Another aspect of the present invention comprises a dishwasher apparatus, comprising a pump in fluid communication with at least one wash arm and adapted to provide a washing fluid thereto. A filter device is in fluid communication with the pump and is configured to receive at least a portion of the washing fluid therefrom. The filter device includes an elongate housing having opposed ends, with one of the ends defining a fluid inlet. The housing is configured to define a channel therein extending between the opposed ends and has an upper wall and substantially vertical opposing side walls extending therefrom. The upper wall comprises a solid member, and at least one of the side walls comprises a fine mesh filtering screen, wherein washing fluid directed into the fluid inlet is filtered by the fine mesh filtering screen such that soil suspended therein is retained within the channel while the washing fluid passes through the fine mesh filtering screen and out of the channel.

Another aspect of the present invention comprises a method of filtering washing fluid in a dishwasher. Such a method comprises directing washing fluid into a fluid inlet defined by one end of an elongate housing having opposed ends, wherein the housing is configured to define a channel therein extending between the opposed ends and has a substantially horizontal upper wall and substantially vertical opposing side walls extending therefrom. The upper wall comprises a solid member, and at least one of the side walls comprises a fine mesh filtering screen. The washing fluid is then filtered with the fine mesh filtering screen such that soil suspended therein is retained within the channel, while the washing fluid passes through the fine mesh filtering screen and out of the channel.

Aspects of the present invention thus provide significant advantages as further detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic perspective view of a fine filter device according to one embodiment of the present invention as implemented in a dishwasher apparatus;

FIG. 2 is a schematic side view of a fine filter device according to one embodiment of the present invention;

FIGS. 3A-3D are schematic cross-sectional views of various embodiments of a fine filter device according to the present invention; and

FIG. 4 is a schematic plan view of a fine filter device according to one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

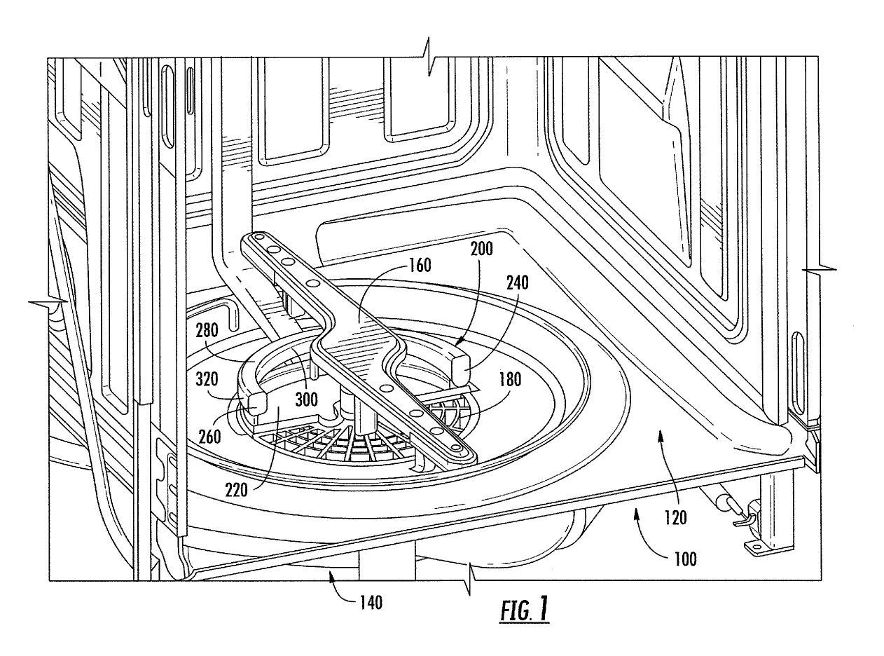

FIG. 1 schematically illustrates a dishwasher apparatus according to one embodiment of the present invention, the dishwasher apparatus being generally indicated by the numeral 100. Such a dishwasher apparatus 100 includes a front-opening wash tub 120 for receiving dishware (not shown) to be washed. Associated with the tub 120 is a sump 140 defined by or otherwise disposed about the lower end of the tub 120, wherein the sump 140 is configured to collect, under the influence of gravity, the dishwashing fluid circulated in the tub 120. Typically, the dishwashing fluid, such as water, is circulated by a circulation pump (not shown) and sprayed or otherwise dispensed through one or more spray arms 160 operably arranged within and/or with respect to the tub 120. The fluid dispensed through the spray arm(s) 160 is directed onto the dishware within the tub 120 for removing food soils and other debris therefrom. After interacting with the dishware, the used dishwashing fluid typically drains under the influence of gravity into the sump 140, along with food soils and debris from the dishware.

In general, the dishwashing fluid collected in the sump 140 is re-circulated through the spray arm(s) 160 during each of the wash and rinse cycles typically implemented by the dishwasher apparatus 100. However, since it is undesirable to re-circulate the food soils and debris back through the hydraulic system of the dishwasher apparatus 100, the dishwasher apparatus 100 includes a filtration arrangement associated with the circulation system. For example, the dishwasher apparatus 100 may include a coarse filtration or strainer device 180 for straining the dishwashing fluid to remove and retain relatively large particles of the food soils and other debris dislodged from the dishware. In some instances, the coarse filtration device 180 separates the tub 120 from the sump 140 such that the relatively large particles strained from the dishwashing fluid are retained outside the sump 140.

Since the dishwashing fluid is re-circulated during, for example, each of the wash and rinse cycles, it is desirable to remove as much particulates from the dishwashing fluid as practicable and/or possible. As such, one aspect of the present invention comprises a fine filter device 200 operably engaged with the hydraulic system of the dishwasher apparatus 100 for removing relatively small or fine particles from the dishwashing fluid. In one embodiment, the fine filter device 200 is disposed within the tub 120 and substantially external to the sump 140, as shown in FIG. 1. That is, the fine filter device 200 may be disposed opposite the coarse filtration device 180, or other member 220 separating the tub 120 and sump 140, from the sump 140. However, the fine filter device 200 may alternatively be disposed on the sump side of the tub/sump separating member 220, as appropriate.

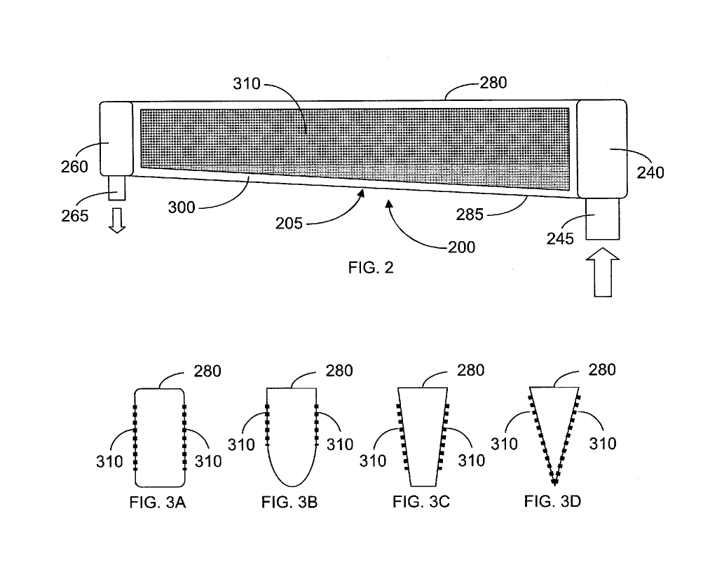

In one embodiment, the fine filter device 200 comprises an elongate housing 205 (see, e.g., FIG. 2) having opposed ends 240, 260, and defining a channel (not shown) therein extending between the opposed ends 240, 260. One of the ends 240 or 260 defines a fluid inlet 245 (see, e.g., FIG. 2) into the interior channel of the fine filter device 200. In the illustrated embodiment, the housing 205 may be arcuately configured and disposed about a rotational axis of the spray arm(s) 160. In particular embodiments, the arcuate housing 205 may have a radius R (see, e.g., FIG. 3) corresponding to an installation distance from the rotational axis of the spray arm(s) 160. In any instance, though disclosed herein in exemplary terms of an arcuate housing, one skilled in the art will appreciate that the elongate housing 205 may be implemented in many different forms consistently with the scope of the present application.

The arcuate housing between the opposed ends 240, 260 is configured to have an upper wall 280 and substantially vertical opposing side walls 300, 320 extending therefrom. In one aspect, the upper wall 280 may be substantially horizontally disposed. In another aspect, the upper wall 280 comprises a solid or substantially solid member. Further, at least one of the side walls 300, 320 comprises a fine mesh filtering screen 310 (i.e., both side walls 300, 320, in some instances, such as shown, for example, in FIGS. 3A-3D, may comprise the fine mesh filtering screen 310), such as shown, for example, in FIG. 2, configured to remove the relatively fine particles from the dishwashing fluid, wherein such relatively fine particles are smaller than the relatively large particles strained by the coarse filtration device 180. In still another aspect, the housing 205 may also include a lower wall 285 (see, e.g., FIG. 2) operably engaged with the side walls 300, 320. One skilled in the art will appreciate, from the disclosure herein, that one of the advantages of the side wall(s) including the fine mesh filtering screen is that the upper wall 280 protects the fine mesh filtering screen 310 from falling objects. As such, the side walls 300, 320 may be configured in different manners, as long as the fine mesh filtering screen 310 is protected by the upper wall 280 (see, e.g., FIGS. 3A-3D). For example, the side walls 300, 320 may be configured to extend from the upper wall 280 and to converge toward and engage each other therebelow, such that the lower wall 285 is eliminated (see, e.g., FIG. 3D).

In the disclosed configuration and implementation, at least a portion of the dishwashing fluid, strained by the coarse filtration or strainer device 180 and collected in the sump 140, is directed into the fluid inlet 245 of the fine filter device 200 by the circulation pump or other component of the hydraulic system of the dishwasher apparatus 100. The at least a portion of the dishwashing fluid directed into the interior channel of the fine filter device 200 is filtered by the fine mesh filtering screen 310 comprising at least one of the side walls 300, 320 such that the relatively fine particles or soil suspended in the dishwashing fluid is filtered and retained within the channel. The fine-filtered dishwashing fluid thus passes through the fine mesh filtering screen 310 and out of the channel, to again pass through the coarse filtration device 180 and into the sump 140 for re-circulation through the hydraulic system of the dishwasher apparatus 100.

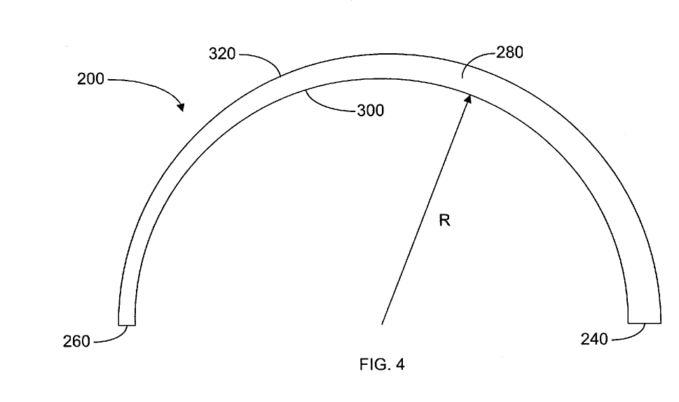

In some instances, the volume of the dishwashing fluid capable of passing through the fine mesh filtering screen 310 may be less than the volume of the dishwashing fluid directed into the fine filter device 200 through the fluid inlet 245. As such, in some instances, the fine filter device 200 may experience a positive pressure within the interior channel thereof. Such a positive pressure may be achieved in different manners, as will be appreciated by one skilled in the art. For example, the area of the fluid inlet 245 may be greater than the fluid outlet 265 (see, e.g., FIG. 2), such that the excess dishwashing fluid is directed through the fine mesh filtering screen 310. In another example, the cross-sectional area of the interior channel of the housing 205 may be configured to decrease as the channel extends from the fluid inlet 245 toward the fluid outlet 265 (see, e.g., FIGS. 2 and 4) In one example of such a decreasing cross-sectional area, as shown in FIG. 2, the side walls 300, 320 may be further configured to taper as the interior channel extends from the fluid inlet 245 toward the fluid outlet 265 such that the lower wall 285 converges toward the upper wall 280 as the interior channel approaches the fluid outlet 265. In another example of such a decreasing cross-sectional area, as shown in FIG. 4, at least one of the upper wall 280 and the lower wall 285 (if present) may be configured to taper as the interior channel extends from the fluid inlet 245 toward the fluid outlet 265 such that at least one of the side walls 300, 320 converges toward the other as the interior channel approaches the fluid outlet 265.

Further, since the fine filter device 200 is configured to retain the relatively fine particulates therein, the fine filter device 200 must be periodically flushed or otherwise cleaned to remove the particulates. Accordingly, in some instances, the fine filter device 200 may be configured to be readily removed from the dishwasher apparatus 100 so as to allow cleaning thereof externally to the dishwasher apparatus 100. However, the fine filter device 200 may be cleaned in other ways. For example, during a drain cycle where the dishwashing fluid is drained from the dishwasher apparatus 100, the dishwashing fluid may cease to be directed into the fluid inlet of the fine filter device 200, thereby relieving the positive pressure therein and allowing the dishwashing fluid within the interior channel to drain therefrom, for instance, through the fine mesh filtering screen 310, through the fluid inlet 245, or through the fluid outlet 265 that is configured to be fluidly open to the house drain or selectively opened to the house drain (i.e., only during the drain cycle). Once the fine filter device 200 is in the drain mode, the spray arm(s) 160 (i.e., the spray arm(s) 160 may include one of more nozzles (not shown) directed at the fine filter device 200) or other component of the hydraulic system may be configured to direct some of the dishwashing fluid toward an external surface of the fine mesh filtering screen 310 so as to “back flush” the fine filter device 200 (i.e., flush soils retained by the fine mesh filtering screen 310 back into the interior channel such that the soils are removed through the fluid outlet 265).

According to one aspect of the present invention, the fine filter device 200, configured as described with the substantially horizontal and substantially solid upper wall 280, with at least one of the substantially vertical opposing side walls 300, 320 being comprised of the fine mesh filtering screen 310, may further comprise a substantially vertically-oriented fine filtering device 200 since the fine mesh filtering material 310 is substantially vertically disposed. In such a substantially vertical orientation, the fine mesh filtering material 310 is at less or minimal risk of being damaged by falling dishware objects, such as cutlery. The substantially horizontal and substantially solid upper wall 280 may also serve to protect the fine mesh filtering material 310 from impact. Therefore, the substantially vertically-oriented fine filter device 200 may allow the dishwashing device 100 to include less or no additional provisions for providing impact protection for the fine filter device 200. In addition, the vertical orientation of the fine filter device 200 may also provide a reduced horizontal footprint, thus conserving space within the tub 120 and/or allowing alternate configurations of components about the lower end of the tub 120 and about the interface with the sump 140.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A filter device for a dishwasher, comprising:
an elongate housing having opposed ends, one of the ends defining a fluid inlet, the housing being configured to define a channel therein extending between the opposed ends and having an upper wall and substantially vertical opposing side walls extending therefrom, the upper wall comprising a solid member, and at least one of the side walls comprising a fine mesh filtering screen, wherein washing fluid directed into the fluid inlet is filtered by the fine mesh filtering screen such that soil suspended therein is retained within the channel while the washing fluid passes through the fine mesh filtering screen and out of the channel.

2. A device according to claim 1, wherein the upper wall is substantially horizontal.

3. A device according to claim 1, wherein the opposing side walls both comprise the fine mesh filtering screen.

4. A device according to claim 1, wherein the housing further defines a fluid outlet at the end opposing the end defining the fluid inlet, the fluid outlet being configured to at least partially allow drainage of washing fluid from within the channel.

5. A device according to claim 4, wherein the channel defines a cross-sectional area, and wherein the cross-sectional area decreases as the channel extends from the fluid inlet toward the fluid outlet, the decreasing cross-sectional area thereby producing a backpressure within the channel for directing the washing fluid through the at least one of the side walls comprising the fine mesh filtering screen.

6. A device according to claim 5, further comprising a lower wall operably engaged with the side walls, and wherein the side walls taper as the channel extends from the fluid inlet toward the fluid outlet and the lower wall converges toward the upper wall so as to decrease the cross-sectional area of the channel as the channel extends from the fluid inlet toward the fluid outlet.

7. A device according to claim 5, further comprising a lower wall operably engaged with the side walls, and wherein at least one of the upper and lower walls taper as the channel extends from the fluid inlet toward the fluid outlet and at least one of the side walls converges toward the other so as to decrease the cross-sectional area of the channel as the channel extends from the fluid inlet toward the fluid outlet.

8. A device according to claim 1, wherein the housing is arcuately configured and adapted to have a radius corresponding to an installation distance from a rotational axis of a wash arm.

9. A dishwasher apparatus, comprising:
a pump in fluid communication with at least one wash arm and adapted to provide a washing fluid thereto; and
a filter device in fluid communication with the pump and configured to receive at least a portion of the washing fluid therefrom, the filter device including an elongate housing having opposed ends, one of the ends defining a fluid inlet, the housing being configured to define a channel therein extending between the opposed ends and having an upper wall and substantially vertical opposing side walls extending therefrom, the upper wall comprising a solid member, and at least one of the side walls comprising a fine mesh filtering screen, wherein washing fluid directed into the fluid inlet is filtered by the fine mesh filtering screen such that soil suspended therein is retained within the channel while the washing fluid passes through the fine mesh filtering screen and out of the channel.

10. An apparatus according to claim 9, wherein the upper wall is substantially horizontal.

11. An apparatus according to claim 9, wherein the opposing side walls both comprise the fine mesh filtering screen.

12. An apparatus according to claim 9, wherein the housing further defines a fluid outlet at the end opposing the end defining the fluid inlet, the fluid outlet being configured to at least partially allow drainage of washing fluid from within the channel.

13. An apparatus according to claim 12, wherein the channel defines a cross-sectional area, and wherein the cross-sectional area decreases as the channel extends from the fluid inlet toward the fluid outlet, the decreasing cross-sectional area thereby producing a backpressure within the channel for directing the washing fluid through the at least one of the side walls comprising the fine mesh filtering screen.

14. An apparatus according to claim 13, further comprising a lower wall operably engaged with the side walls, and wherein the side walls taper as the channel extends from the fluid inlet toward the fluid outlet and the lower wall converges toward the upper wall so as to decrease the cross-sectional area of the channel as the channel extends from the fluid inlet toward the fluid outlet.

15. An apparatus according to claim 13, further comprising a lower wall operably engaged with the side walls, and wherein at least one of the upper and lower walls taper as the channel extends from the fluid inlet toward the fluid outlet and at least one of the side walls converges toward the other so as to decrease the cross-sectional area of the channel as the channel extends from the fluid inlet toward the fluid outlet.

16. An apparatus according to claim 9, wherein the housing is arcuately configured and further configured to have a radius corresponding to an installation distance from a rotational axis of the at least one wash arm.

17. An apparatus according to claim 9 wherein the at least one wash arm further defines at least one nozzle configured to direct at least a portion of the washing fluid received thereby toward an external surface of the at least one of the side walls comprising the fine mesh filtering screen so as to flush soil retained by the fine mesh filtering screen into the channel.

18. A method of filtering washing fluid in a dishwasher, comprising:
directing washing fluid into a fluid inlet defined by one end of an elongate housing having opposed ends, the housing being configured to define a channel therein extending between the opposed ends and having a substantially horizontal upper wall and substantially vertical opposing side walls extending therefrom, the upper wall comprising a solid member, and at least one of the side walls comprising a fine mesh filtering screen; and
filtering the washing fluid with the fine mesh filtering screen such that soil suspended therein is retained within the channel, while the washing fluid passes through the fine mesh filtering screen and out of the channel.

19. A method according to claim 18, wherein the housing further defines a fluid outlet at the end opposing the end defining the fluid inlet, and the method further comprises draining at least a portion of the washing fluid from within the channel through the fluid outlet.

20. A method according to claim 19, wherein the channel defines a cross-sectional area, and the method further comprises producing a backpressure within the channel for directing the washing fluid through the at least one of the side walls comprising the fine mesh filtering screen by decreasing the cross-sectional area as the channel extends from the fluid inlet toward the fluid outlet.

21. A method according to claim 20, wherein the housing further comprises a lower wall operably engaged with the side walls, and the method further comprises decreasing the cross-sectional area of the channel as the channel extends from the fluid inlet toward the fluid outlet by tapering the side walls as the channel extends from the fluid inlet toward the fluid outlet such that the lower wall converges toward the upper wall.

22. A method according to claim 20, further comprising a lower wall operably engaged with the side walls, and the method further comprises decreasing the cross-sectional area of the channel as the channel extends from the fluid inlet toward the fluid outlet by tapering at least one of the upper and lower walls taper as the channel extends from the fluid inlet toward the fluid outlet such that at least one of the side walls converges toward the other.

23. A method according to claim 18, wherein the housing is arcuately configured, the method further comprises directing at least a portion of the washing fluid toward an external surface of the at least one of the side walls comprising the fine mesh filtering screen so as to flush soil retained by the fine mesh filtering screen into the channel.
